(19) United States
(12) Patent Application Publication
(10) Pub. No.: US 2024/0377515 A1
(43) Pub. Date: Nov. 14, 2024

(54) IMAGING UNIT AND IMAGING METHOD

(71) Applicant: Japan Display Inc., Tokyo (JP)

(72) Inventors: Hirondo NAKATOGAWA, Tokyo (JP); Yoshiro AOKI, Tokyo (JP); Hitoshi TANAKA, Tokyo (JP)

(21) Appl. No.: 18/653,073

(22) Filed: May 2, 2024

(30) Foreign Application Priority Data
May 10, 2023 (JP) 2023-078002

(51) Int. Cl. G01S 7/497; G01S 7/4863; G01S 7/4865; G01S 17/894

(52) U.S. Cl. CPC G01S 7/497; G01S 7/4863; G01S 7/4865; G01S 17/894

(57) ABSTRACT

An imaging unit includes an imaging apparatus having an aperture unit and an imaging device, a TOF sensor measuring a time between reflection of emitted light by a surface of an arbitrary imaging object and return, a ranging result acquisition unit acquiring first depth information in each of a plurality of pixels of the imaging device, an actual distance acquisition unit acquiring second depth information of the imaging object based on a measurement result of the TOF sensor, a memory unit correlating and storing a relationship between the first depth information and the second depth information with an environmental temperature, a temperature acquisition unit acquiring an environmental temperature based on the first depth information and the second depth information, and a correction unit correcting the first depth information in each of the plurality of pixels based on the environmental temperature.

### CROSS-REFERENCE TO RELATED APPLICATION

The present application claims priority from Japanese application JP 2023-078002 filed on May 10, 2023, the content of which is hereby incorporated by reference into this application.

### BACKGROUND OF THE INVENTION

### 1. Field of the Invention

The present invention relates to an imaging unit and an imaging method.

### 2. Description of the Related Art

Hajime Nagahara: Coded Imaging, IPSJ SIG Technical Report, Vol. 2010-CVIM-171, No. 14, pp. 1-9, 2010 describes an explanation of a coded imaging method. In the coded imaging method, a technique called Depth From Defocus (DFD) of estimating a depth of a scene from blur of an image by using masks having various patterns as apertures (coded apertures) and controlling a general blur function (PSF) and frequency characteristics thereof is available.

Here, ranging accuracy by an imaging apparatus using the coded imaging method depends on a distance between an optical system containing a lens and an imaging device (image sensor), i.e., a focal length. Accordingly, when the optical system or the imaging device is displaced, accurate ranging may be hard. One of factors causing displacement of the optical system or the imaging device is a change in environmental temperature.

### SUMMARY OF THE INVENTION

The invention is achieved in view of the above described circumstances and a purpose thereof is to increase ranging accuracy.

In order to solve the above described problem, an imaging unit according to the application includes an imaging apparatus having an optical system, an aperture unit in which a coded aperture pattern partially shielding incident light to the optical system is formed, and an imaging device acquiring image data based on the incident light passing through the optical system, a correction sensor measuring a time between reflection of emitted light by a surface of an arbitrary imaging object and return, a first depth information acquisition unit acquiring first depth information in each of a plurality of pixels of the imaging device based on a blur function according to the coded aperture pattern, a second depth information acquisition unit acquiring second depth information of the imaging object based on a measurement result of the correction sensor, a memory unit correlating and storing a relationship between the first depth information and the second depth information with an environmental temperature, a temperature acquisition unit acquiring an environmental temperature based on the first depth information of the imaging object acquired by the first depth information acquisition unit and the second depth information of the imaging object acquired by the second depth information acquisition unit, and a correction unit correcting the first depth information in each of the plurality of pixels based on the environmental temperature acquired by the temperature acquisition unit.

Further, in order to solve the above described problem, an imaging method according to the application includes a procedure of acquiring image data based on incident light passing through an aperture unit in which a coded aperture pattern partially shielding incident light to the optical system is formed, and acquiring first depth information in each of a plurality of pixels of an imaging device, a procedure of acquiring second depth information of the imaging object based on a measurement result of a correction sensor that measures a time between reflection of emitted light by a surface of an arbitrary imaging object and return, a procedure of acquiring an environmental temperature based on the first depth information and the second depth information using a memory unit correlating and storing a relationship between the first depth information and the second depth information with the environmental temperature, and a procedure of correcting the first depth information in each of the plurality of pixels based on the acquired environmental temperature.

### BRIEF DESCRIPTION OF THE DRAWINGS

FIG. 1 is a schematic diagram schematically showing an imaging unit according to an embodiment.

FIG. 2 is a functional block diagram showing an example of functions realized by a control section in the embodiment.

FIG. 3 is a graph showing an example of a relationship between a ranging result by an imaging apparatus an environmental temperature.

FIG. 4 shows an example of a table stored by a memory unit.

FIG. 5 is a diagram for explanation of correction of depth information with respect to each pixel.

FIG. 6 shows a flowchart of correction processing in the embodiment.

### DETAILED DESCRIPTION OF THE INVENTION

In the application, in the drawings, for clearer explanation, widths, thicknesses, shapes, etc. of the respective parts may be schematically shown in comparison with the real configurations, however, are just examples and do not limit the interpretation of the invention. In the specification and the respective drawings, the elements having the same functions as those explained with respect to the previously described drawing may have the same signs and the overlapping explanation thereof may be omitted.

### Summary of Overall Configuration of Imaging Unit 100

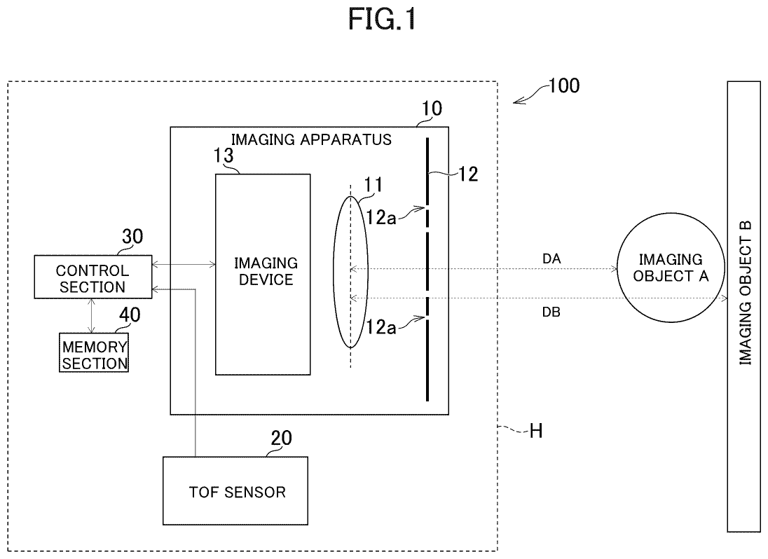

First, referring to FIG. 1, the summary of an overall configuration of an imaging unit 100 according to an embodiment will be explained. FIG. 1 is a schematic diagram schematically showing the imaging unit according to the embodiment. The imaging unit 100 according to the embodiment includes an imaging apparatus 10 and a TOF (Time Of Flight) sensor 20, and a housing H housing the apparatus and the sensor. Further, the imaging unit 100 includes a control section 30 and a memory section 40.

FIG. 1 schematically shows a state in which the imaging unit 100 acquires an image showing an imaging object A at a distance DA from the imaging unit 100 and an imaging object B at a distance DB from the imaging unit 100. Note that the distance DA may be a distance from a surface of the imaging object A to the center of a lens 11 and the distance DB may be a distance from a surface of the imaging object B to the center of the lens 11.

The imaging apparatus 10 is a camera that can acquire a distance in a depth direction of an imaging object using a coded imaging method of observing blur. The imaging apparatus 10 may be a digital camera or a camera provided in a smartphone or the like.

The imaging apparatus 10 includes an optical system containing at least one lens 11, an aperture unit 12 in which coded apertures 12a for focusing outside light passing through the optical system using aperture patterns are formed, and an imaging device 13. The imaging apparatus 10 may have various configurations mounted on common cameras for realization of imaging functions, not limited to the configuration shown in FIG. 1. For example, the imaging apparatus 10 may have a shutter that adjusts the exposure of the outside light to the imaging device 13 or the like.

The lens 11 may be one used for a common camera and may be configured to adjust the focal length. Note that, in FIG. 1, the single lens 11 is schematically shown, however, the optical system may include a plurality of lens groups.

The aperture unit 12 partially shields the outside light entering the lens 11. The coded apertures 12a are formed in the aperture unit 12. In the imaging unit 100, a technique called Depth from defocus (DFD) of estimating a depth of a scene from blur of an image by using the aperture unit 12 with the coded apertures 12a formed therein as an aperture (coded aperture) and controlling a point spread function (hereinafter, also simply referred to as PSF) and frequency characteristics thereof is used. The PSF may also be called a blur function. The aperture unit 12 is a liquid crystal shutter and may be configured to change the aperture patterns of the coded apertures 12a.

The imaging device 13 may be a CMOS (complementary metal oxide semiconductor) sensor or a CCD (charge coupled device) used for a common camera. The image detected by the imaging device 13 may be a color image or a monochrome image.

The control section 30 may be an information processing unit including at least one processor. The control section 30 acquires depth information of a captured image by processing image data obtained by the imaging device 13. The control section 30 may be configured to acquire depth information of each of the plurality of pixels of the imaging device 13 by restoration processing based on the blur function according to the aperture patterns of the coded apertures 12a of the aperture unit 12.

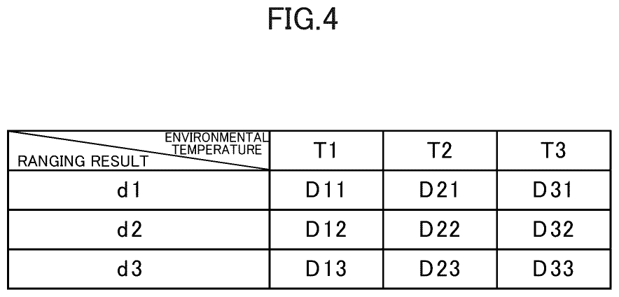

Information for correction of the depth information is stored in the memory section 40. The information stored in the memory section 40 will be described later with reference to FIG. 4.

The TOF sensor 20 is a sensor detecting depth information of the imaging object by measuring a time between reflection of emitted light by the surface of the imaging object and return. The TOF sensor 20 may include a light emitting unit outputting emitted light and a receiving unit receiving the light reflected by the surface of an arbitrary imaging object and returning. Note that, in the embodiment, the TOF sensor 20 is explained as an example of a correction sensor, however, not limited thereto, may be another range sensor. For example, as the correction sensor, an ultrasonic range sensor, an infrared range sensor, a millimeter-wave radar, or the like may be used.

### [Functions Realized by Control Section 30]

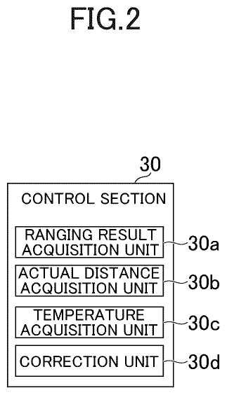

FIG. 2 is a functional block diagram showing an example of functions realized by the control section in the embodiment. The respective functions shown in FIG. 2 are realized by a computer executing programs. The programs may be stored in a computer-readable information recording medium.

In the control section 30, a ranging result acquisition unit 30a as a first depth information acquisition unit, an actual distance acquisition unit 30b as a second depth information acquisition unit, a temperature acquisition unit 30c, and a correction unit 30d are realized.

The ranging result acquisition unit 30a acquires a ranging result (first depth information) measured by the imaging apparatus 10. The actual distance acquisition unit 30b acquires a ranging result (second depth information) measured by the TOF sensor 20. The temperature acquisition unit 30c acquires an environmental temperature T based on the ranging result acquired by the ranging result acquisition unit 30a and the ranging result acquired by the actual distance acquisition unit 30b. The correction unit 30d corrects the ranging result in each of the plurality of pixels of the imaging device 13 based on the environmental temperature T acquired by the temperature acquisition unit 30c. Note that, in the embodiment, the environmental temperature T refers to an air temperature around the lens 11 and the imaging device 13 or a temperature of the lens 11 and the imaging device 13 holding heat generated according to the air temperature and driving of an apparatus.

### [Correction of Depth Information]

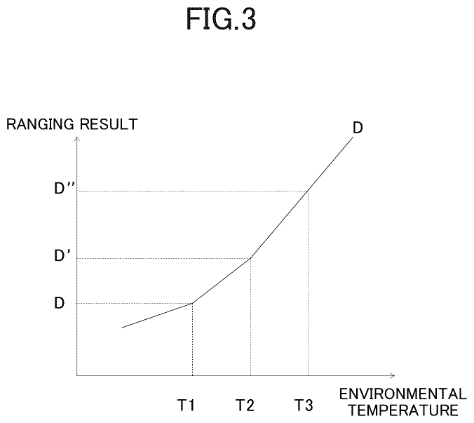

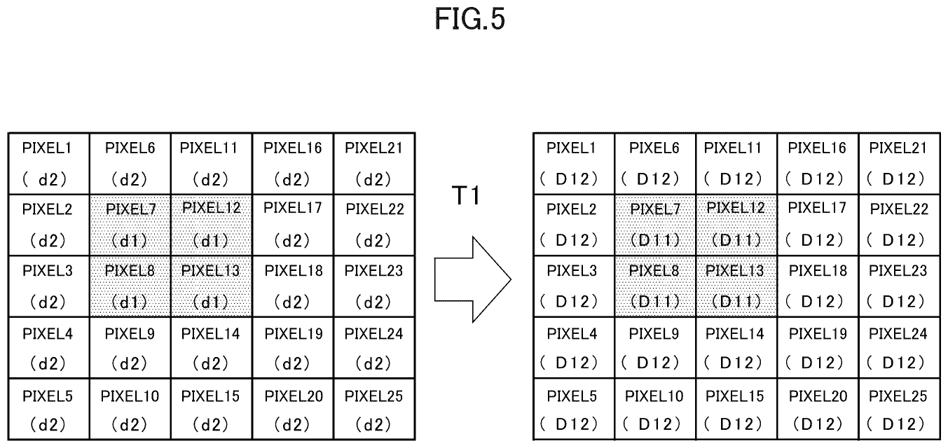

Next, correction of the depth information in the embodiment will be explained with reference to FIGS. 1 to 5. FIG. 3 is a graph showing an example of a relationship between the ranging result by the imaging apparatus and the environmental temperature. FIG. 4 shows an example of a table stored by the memory section. FIG. 5 is a diagram for explanation of correction of the depth information with respect to each pixel.

Here, in Hajime Nagahara: Coded Imaging, IPSJ SIG Technical Report, Vol. 2010-CVIM-171, No. 14, pp. 1-9, 2010, the following expression (1) is shown. The expression (1) expresses a size b of blur.

$$b = \frac{a}{v} \vert ( v - p ) \vert \qquad ( 1 )$$

In the expression (1), a is a size of an aperture. p is a distance between the imaging device 13 and the lens 11. v is a distance between the lens 11 and a point at which incident light is focused. That is, v is a distance from the lens 11 to an image. From the expression (1), a degree of blur is determined based on the size a of an aperture, the distance v from the lens 11 to an image, and the distance p between the lens 11 and the imaging device 13. If these respective parameters change, the degree of blur is not accurately acquired. That is, the accuracy of the depth information acquired in the imaging apparatus 10 becomes lower. Note that, from the expression (1), if v and p are equal, the blur size is zero. That is, a focused image may be obtained.

Here, from an experimental result of the inventor of the application, it is known that, in the imaging apparatus 10 acquiring depth information by observing blur using the coded apertures 12a, acquisition of accurate depth information is hard depending on the environmental temperature T. FIG. 3 shows a result of ranging of an imaging object at an actual distance D by the imaging apparatus 10 while the temperature is changed.

As shown in FIG. 3, in an environment at an environmental temperature T1, the ranging result is D equal to the actual distance D. In an environment at an environmental temperature T2 (>T1), the ranging result is D′ (>D) longer than the actual distance D. In an environment at an environmental temperature T3 (>T1), the ranging result is D″ (>D′) longer than that in the environment at the environmental temperature T2. As described above, the higher the environmental temperature T, the longer than the actual distance the ranging result by the imaging apparatus 10. It is considered that this is because the distance between the lens 11 and the imaging device 13 changes as the environmental temperature T is higher. That is, it is considered that this is because the lens 11 and the imaging device 13 expand or contract depending on the environmental temperature T and the distance therebetween changes. Note that, as shown by the above described expression (1), the blur size depends on the distance p between the lens 11 and the imaging device 13.

Accordingly, in the embodiment, a configuration in which relationships between the depth information (ranging results) acquired by the imaging apparatus 10 and actual distances are stored in advance with respect to each environmental temperature T as a table and the environmental temperature T is estimated based on the table and the depth information is corrected is employed. Note that the table shown in FIG. 4 may be stored in the memory section 40.

The actual distance is a real distance from the imaging apparatus 10 to the imaging object. Here, the TOF sensor 20 is for measuring the distance in the depth direction like the imaging apparatus 10, however, performs ranging using a different technique from the ranging technique of the imaging apparatus 10 having the lens 11 and the imaging device 13 and using blur by the coded apertures 12a. Accordingly, the TOF sensor 20 may measure the distance in the depth direction with higher accuracy regardless of the environmental temperature T. In the embodiment, the depth information acquired by the TOF sensor 20 is regarded as the actual distance.

In the embodiment, ranging is performed in advance by the imaging apparatus 10 and the relationship between the ranging result and the real distance with respect to each environmental temperature T is acquired, and thereby, the table shown in FIG. 3 is created. The ranging may be performed in, for example, a laboratory in which the room temperature can be appropriately changed.

As shown in FIG. 4, in the environment at the environmental temperature T1, an actual distance of the imaging object when a ranging result is d1 was D11. Further, in the environment at the environmental temperature T1, an actual distance of the imaging object when a ranging result is d2 was D12. Furthermore, in the environment at the environmental temperature T1, an actual distance of the imaging object when a ranging result is d3 was D13. As shown in FIG. 4, the relationships between the ranging results and the actual distances may be acquired in the same manner at the environmental temperatures T2, T3.

As below, referring to FIG. 5, an example of correction of the depth information using the table stored in the memory section 40 in advance will be explained. In FIG. 5, a pixel group before correction of depth information and a pixel group after correction of depth information are shown. Further, FIG. 5 shows an example in which the imaging object A is displayed in pixels 7, 8, 12, 13 and the imaging object B is displayed in the other pixels. That is, the pixels 7, 8, 12, 13 contain depth information of the imaging object A and the other pixels contain depth information of the imaging object B.

Here, when the imaging object A is imaged, if the ranging result by the imaging apparatus 10 was d1 and the actual distance acquired by the TOF sensor 20 was D11, the control section 30 determines that the environmental temperature is T1 with reference to the table shown in FIG. 4. Then, the control section 30 corrects the depth information in the pixels in which the imaging object A is displayed to D11.

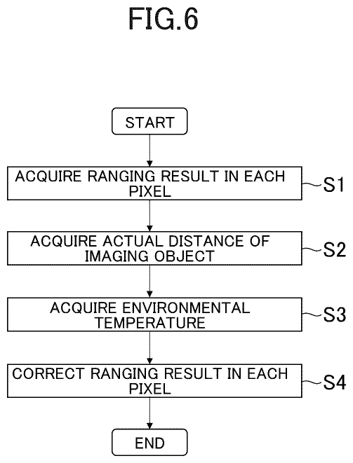

As shown in FIG. 5, in the imaging object B as the background of the imaging object A, the ranging result by the imaging apparatus 10 was d2. Accordingly, the control section 30 corrects the depth information of the imaging object B with reference to the table shown in FIG. 4. Specifically, the control section 30 determines that the actual distance of the imaging object B is D12 because of the ranging result d2 at the environmental temperature T1. Note that, similarly, if the ranging result contains the pixel of d3, the control section 30 may determine the actual distance in the pixel as D13. [Flowchart] Next, referring to FIG. 6, correction processing of depth information in the embodiment will be explained. FIG. 6 shows a flowchart of the correction processing in the embodiment.

First, by the ranging result acquisition unit 30a, depth information as a ranging result is acquired in each pixel contained in an image acquired by the imaging apparatus 10 (S1). Further, by the actual distance acquisition unit 30b, an actual distance of the imaging object A acquired by the TOF sensor 20 is acquired (S2). Note that the order of S1 and S2 may be reversed or S1 and S2 may be performed at the same time.

Furthermore, by the temperature acquisition unit 30c, an environmental temperature is acquired with reference to the table stored in the memory section 40 based on the depth information of the imaging object A in the plurality of pixels acquired by the imaging apparatus 10 and the actual distance of the imaging object A acquired by the TOF sensor 20 (S3). Then, by the correction unit 30d, the depth information as the ranging result in each pixel contained in the image acquired by the imaging apparatus 10 is corrected based on the acquired environmental temperature (S4).

### SUMMARY

In the above described embodiment, the depth information may be accurately acquired regardless of the environmental temperature. Further, in the embodiment, the depth information in all pixels contained in the image acquired by the imaging apparatus 10 may be corrected based on the actual distance of the imaging object acquired by the TOF sensor 20, and a processing load of correction is lower. That is, the processing load is lower than that in a configuration in which actual distances in the respective plurality of pixels contained in the image acquired by the imaging apparatus 10 are acquired by the TOF sensor 20. Further, in the TOF sensor 20, there is an advantage that the ranging result close to the actual distance may be obtained regardless of the environmental temperature, however, there is a disadvantage in susceptibility to outside light and a shorter distance for ranging. In the embodiment, the respective disadvantages of ranging by the coded imaging and ranging by the TOF sensor 20 may be complemented and the depth information can be acquired with higher accuracy.

Note that, in the embodiment, the example in which the table shown in FIG. 4 is stored in the memory section 40 is explained, however, the invention is not limited to that. For example, a function expressing the relationship between the ranging result and the actual distance may be stored in the memory section 40. In this case, the temperature acquisition unit 30c may acquire the environmental temperature based on the function stored in the memory section 40.

What is claimed is:

1. An imaging unit comprising:
an imaging apparatus having an optical system, an aperture unit in which a coded aperture pattern partially shielding incident light to the optical system is formed, and an imaging device acquiring image data based on the incident light passing through the optical system;
a correction sensor measuring a time between reflection of emitted light by a surface of an arbitrary imaging object and return;
a first depth information acquisition unit acquiring first depth information in each of a plurality of pixels of the imaging device;
a second depth information acquisition unit acquiring second depth information of the imaging object based on a measurement result of the correction sensor;
a memory unit correlating and storing a relationship between the first depth information and the second depth information with an environmental temperature;
a temperature acquisition unit acquiring an environmental temperature based on the first depth information of the imaging object acquired by the first depth information acquisition unit and the second depth information of the imaging object acquired by the second depth information acquisition unit; and
a correction unit correcting the first depth information in each of the plurality of pixels based on the environmental temperature acquired by the temperature acquisition unit.

2. An imaging method comprising:
a procedure of acquiring image data based on incident light passing through an aperture unit in which a coded aperture pattern is formed, and acquiring first depth information in each of a plurality of pixels of an imaging device;
a procedure of acquiring second depth information of the imaging object based on a measurement result of a correction sensor that measures a time between reflection of emitted light by a surface of an arbitrary imaging object and return;
a procedure of acquiring an environmental temperature based on the first depth information and the second depth information using a memory unit correlating and storing a relationship between the first depth information and the second depth information with the environmental temperature; and
a procedure of correcting the first depth information in each of the plurality of pixels based on the acquired environmental temperature.
